(19) United States
(12) Patent Application Publication
(10) Pub. No.: US 2024/0261974 A1
(43) Pub. Date: Aug. 8, 2024

(54) Robotic Wire Contact Manipulation and Pose Estimation System

(71) Applicant: The Boeing Company, Arlington, VA (US)

(72) Inventors: Darren Michael Chan, Thousand Oaks, CA (US); Wyatt Spalding McAllister, Santa Monica, CA (US); Heiko Hoffmann, Simi Valley, CA (US)

(21) Appl. No.: 18/164,229

(22) Filed: Feb. 3, 2023

(51) Int. Cl. B25J 9/16; B25J 11/00

(52) U.S. Cl. CPC B25J 9/1697; B25J 9/1664; B25J 11/005

(57) ABSTRACT

A method, apparatus, system, and computer program product for positions a wire contact. A sequence of images of a wire contact is generated while the wire contact moves from a first position to a second position. The sequence of images is generated by the camera system connected to the end effector and the wire contact is held by the end effector. Edges are detected in the sequence of images to form edge images. Background edges are removed from the edges in the edge images leaving contact edges in the edges for the wire contact to form a contact edge image. The wire contact is identified using the contact edges in the contact edge image. A pose of the wire contact is determined from the wire contact identified in the contact edge image.

### BACKGROUND INFORMATION

### 1. Field

The present disclosure relates generally to manufacturing assemblies and in particular, to determining the pose of a wire contact for use in moving wires in a wire bundling assembly process.

### 2. Background

In manufacturing commercial aircraft, wires are often installed in bundles to form wire harnesses. This process involves wires being fed and cut by the machine into desired lengths. Wire contacts are attached to the wires. These wires are placed into a location for assembly using robots. These wires can then be manipulated by a robot with an end effector to form a wire bundle. This robotic end effector can be or can have a wire contact insertion tool.

The end effector picks up wires, moves the wires, and inserts the wire contacts for the wires into electrical connectors. In automating the assembly of wire bundles, accuracy in inserting ends of wires into connectors with high levels of precision is needed. One manner in which automation in assembling wire bundles involves using machine learning models such as neural networks that are trained to move the wires and insert the contacts into connectors. The use of machine learning models can be specific to various types of connectors and settings for wire insulation.

Therefore, it would be desirable to have a method and apparatus that take into account at least some of the issues discussed above, as well as other possible issues. For example, it would be desirable to have a method and apparatus that overcomes a problem with obtaining a desired level of accuracy in inserting wire contacts into connectors.

### SUMMARY

An embodiment of the present disclosure provides a robotic system. The robotic system comprises an end effector, a camera system connected to the end effector, and a controller. The controller is configured to generate a sequence of images of a wire contact while the wire contact moves from a first position to a second position. The sequence of images is generated by the camera system connected to the end effector and the wire contact is held by the end effector. The controller is configured to detect edges in the sequence of images to form edge images. The controller is configured to remove background edges from the edges in the edge images leaving contact edges in the edges for the wire contact to form a contact edge image. The controller is configured to identify the wire contact using the contact edges in the contact edge image. The controller is configured to use a backup to determine a pose of the wire contact from the wire contact identified in the contact edge image.

Another embodiment of the present disclosure provides a method for positioning a wire contact. A sequence of images of a wire contact is generated while the wire contact moves from a first position to a second position. The sequence of images is generated by the camera system connected to the end effector and the wire contact is held by the end effector. Edges are detected in the sequence of images to form edge images. Background edges are removed from the edges in the edge images leaving contact edges in the edges for the wire contact to form a contact edge image. The wire contact is identified using the contact edges in the contact edge image. A pose of the wire contact is determined from the wire contact identified in the contact edge image.

Another embodiment of the present disclosure provides a method for positioning an object. A stereographic camera connected to an end effector generates a sequence of images of the object while the end effector moves the object from a first position to a second position. The object is held by end effector and is fixed in a field of view of the stereographic camera. A computer system processes the sequence of images to identify a pose of the object. The end effector moves the object held by the end effector to a selected position using the pose of the object.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a network of data processing systems in which illustrative embodiments may be implemented;

FIG. 2 is a block diagram of a manufacturing environment in accordance with an illustrative embodiment;

FIG. 3 is an illustration of dataflow for determining the pose of a wire contact in accordance with an illustrative embodiment;

FIG. 4 is an illustration of an end effector for a robotic arm in accordance with an illustrative embodiment;

FIG. 5 is an illustration of a flowchart of a process for positioning a wire contact in accordance with an illustrative embodiment;

FIG. 6 is an illustration of a flowchart of a process for positioning a wire contact in accordance with an illustrative embodiment;

FIG. 7 is an illustration of a flowchart of a process for positioning a wire contact in accordance with an illustrative embodiment;

FIG. 8 is an illustration of a flowchart of a process for detecting edges in accordance with an illustrative embodiment;

FIG. 9 is an illustration of a flowchart of process for removing background edges in accordance with an illustrative embodiment;

FIG. 10 is an illustration of a flowchart of a process for removing edges in accordance with an illustrative embodiment;

FIG. 11 is an illustration of a flowchart of a process for identifying a wire contact in a contact edge image in accordance with an illustrative embodiment;

FIG. 12 is an illustration of a flowchart of a process for processing images to determine the pose of a wire contact using a stenographic camera in accordance with an illustrative embodiment;

FIG. 13 is an illustration of a flowchart of a process for positioning an object in accordance with an illustrative embodiment;

FIG. 14 is an illustration of a flowchart of a process for processing a sequence of images in accordance with an illustrative embodiment;

FIG. 15 is an illustration of a block diagram of a data processing system in accordance with an illustrative embodiment;

FIG. 16 is an illustration of an aircraft manufacturing and service method in accordance with an illustrative embodiment; and

FIG. 17 is an illustration of a block diagram of an aircraft in which an illustrative embodiment may be implemented.

### DETAILED DESCRIPTION

The illustrative embodiments recognize and take into account one or more different considerations. Accuracy in determining the pose of a wire contact is important to perform various operations such as robotic wire insertion. An end effector should be able to insert both ends of a wire in an arbitrary order with a desired level of precision.

Thus, illustrative embodiments provide a method, apparatus, system, and computer program product for determining the pose of a wire contact. The different illustrative examples described herein can perform this pose determination for a wire contact, regardless of its shape, color, and reflectivity of the wire contact. Images of the wire contact are generated during the course of manipulation, which does not require prior modeling. In other words, a machine learning model such as an artificial neural network does not need to be trained to determine the pose of a wire contact in the illustrative examples. Further, the illustrative example can determine the pose of a wire contact during movement of a specular wire contact even though the color and appearance are prone to change during the course of manipulation.

In one illustrative example, a sequence of images of a wire contact are generated while the wire contact moves from a first position to a second position. The sequence of images is generated by the camera system connected to the end effector and the wire contact is held by the end effector. Edges are detected in the sequence of images to form edge images. Background edges are removed from the edges in the edge images leaving contact edges in the edges for the wire contact to form a contact edge image. The wire contact is identified using the contact edges in the contact edge image. A pose of the wire contact is determined from the wire contact identified in the contact edge image.

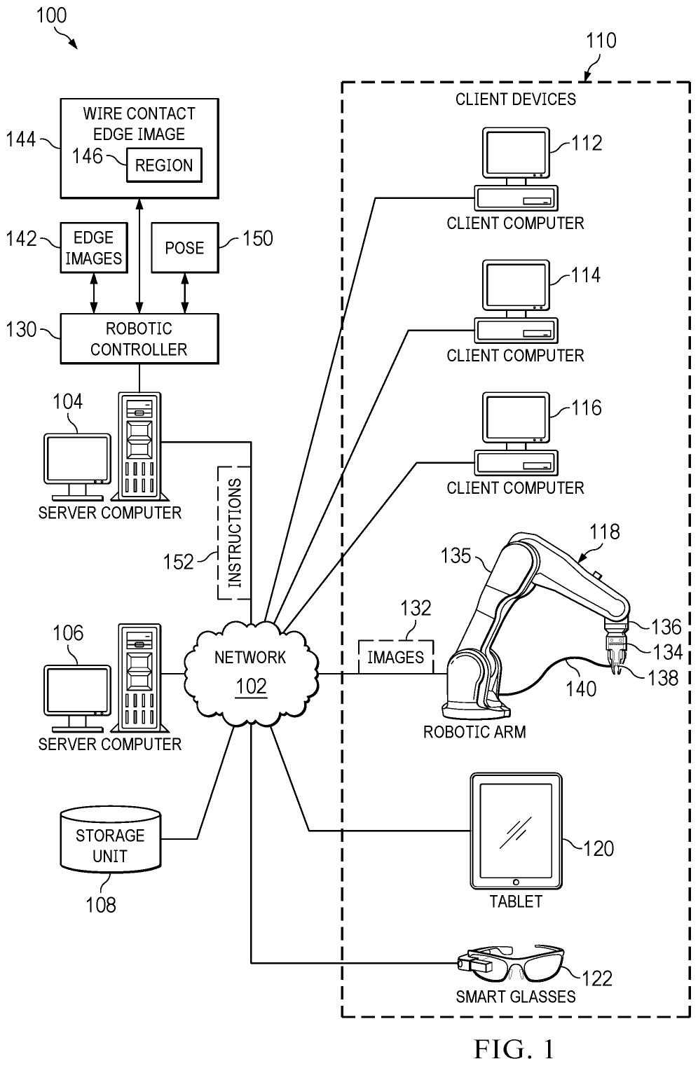

With reference now to the figures and, in particular, with reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client devices 110 connect to network 102. As depicted, client devices 110 include client computer 112, client computer 114, and client computer 116. Client devices 110 can be, for example, computers, workstations, or network computers. In the depicted example, server computer 104 provides information, such as boot files, operating system images, and applications to client devices 110. Further, client devices 110 can also include other types of client devices such as robotic arm 118, tablet computer 120, and smart glasses 122. In this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program instructions located in network data processing system 100 can be stored on a computer-recordable storage medium and downloaded to a data processing system or other device for use. For example, program instructions can be stored on a computer-recordable storage medium on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

As used herein, “a number of” when used with reference to items, means one or more items. For example, “a number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

In this illustrative example, robotic controller 130 is located in server computer 104. Robotic controller 130 can control the operation of robotic arm 118. In this example, robotic controller 130 controls the operation of robotic arm 118 to perform manufacturing operations. For example, robotic arm 118 can be used to assemble wire bundles. As depicted, robotic arm 118 can insert wire contacts for wires into connectors as part of the process for assembling wire bundles.

As depicted, robotic controller 130 can control robotic arm 118 to send images 132 to robotic controller 130 over network 102. Robotic arm 118 has arm 135 connected to end effector 136. In this example, stereoscopic camera 134 connected to end effector 136 of robotic arm 118. As depicted, end effector 136 holds wire 140 having wire contact 138.

Robotic controller 130 controls a stereoscopic camera 134 to generate and send images 132. Images 132 include wire contact 138 in this illustrative example. These images can be generated as robotic arm 118 moves end effector 136 with wire 140 and stereoscopic camera 134 to different positions. For example, images 132 can include one or more images from a first position of end effector 136 holding wire 140. Images 132 is a sequence of images generated by stereoscopic camera 134 during the movement of end effector 136 holding wire 140 from the first position to the second position.

In this illustrative example, robotic controller 130 can analyze images 132 to determine the pose of wire contact 138 at the end of wire 140 held by end effector 136. In this example, the pose of wire contact 138 is the position and orientation of wire contact 138. The position of wire contact 138 can be described in three-dimensional coordinates. The orientation can include a direction of wire contact 138.

Robotic controller 130 can analyze images 132 to identify wire contact 138 in images 132. In this illustrative example, wire contact 138 is in a fixed position and orientation relative to stereoscopic camera 134. In other words, wire contact 138 does not move relative to stereoscopic camera 134 connected to end effector 136. As result, as end effector 136 moves, wire contact 138 remains in a fixed position in images 132. The background in images 132 moves.

With the fixed position of wire contact 138 and the movement of the background in images 132, robotic controller 130 can process images 132 to identify edges in images 132 to form edge images 142. These edge images are processed to identify edges for wire contact 138 in wire contact edge image 144. With this processing, edges corresponding to the background are removed from edge images 142 to form wire contact edge image 144 as part of the process for determining the median over edge images 142. In this example, wire contact edge image 144 is a median of edge images 142.

In this example, robotic controller 130 can determine the pose of wire contact 138 without using complex techniques that involve machine learning models. As depicted, robotic controller 130 determines region 146 in wire contact edge image 144 that contains wire contact 138. This determination of region 146 can be performed using a number of different processes such as an image segmentation algorithm. This type of process can identify the foreground of a target object such as wire contact 138 in wire contact edge image 144. With the identification of region 146 for wire contact 138 in wire contact edge image 144, robotic controller 130 can determine pose 150 of wire contact 138.

With the identification of pose 150, robotic controller 130 can control the movement of arm 135 to move end effector 136 with wire contact 138. This movement can insert wire contact 138 into a hole in the connector. In this example, this movement can be controlled by robotic controller 130 sending instructions 152 from server computer 104 to robotic arm 118 over network 102. These instructions can include commands and data used to operate robotic arm 118. Robotic arm 118 can have a processor or controller that receives instructions 152 and processes instructions 152.

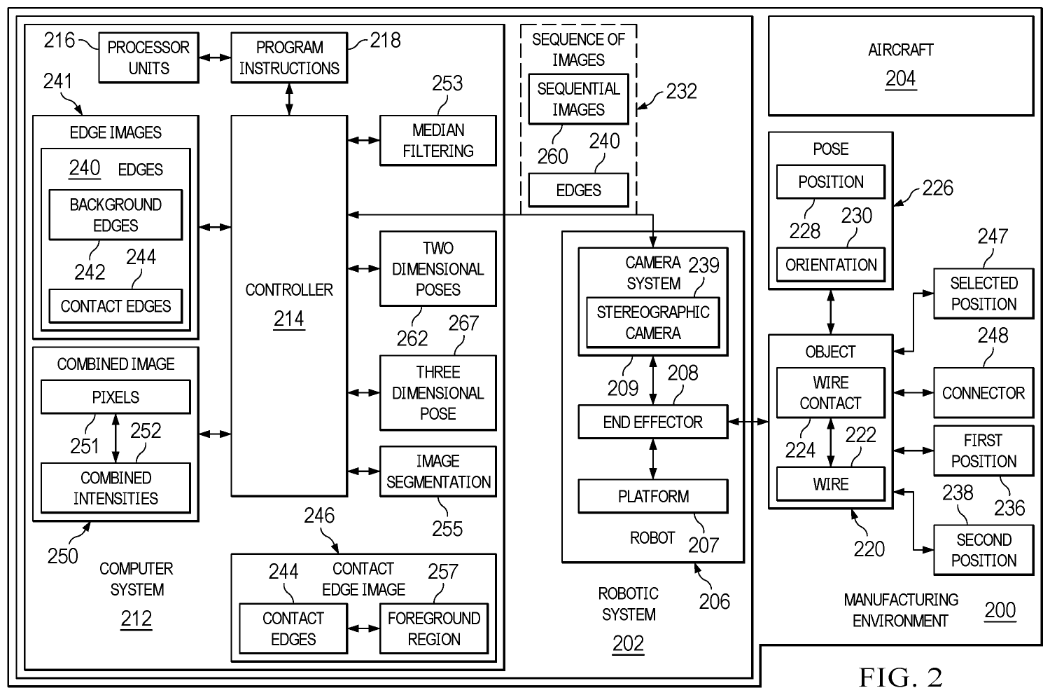

With reference now to FIG. 2, a block diagram of a manufacturing environment is depicted in accordance with an illustrative embodiment. In this illustrative example, manufacturing environment 200 includes components that can be implemented in hardware such as the hardware shown in network data processing system 100 in FIG. 1.

As depicted, robotic system 202 in manufacturing environment 200 can perform operations to manufacture aircraft 204. In this example, aircraft 204 can take a number of different forms. For example, aircraft 204 can be a commercial aircraft, an airplane, a rotorcraft, a tilt-rotor aircraft, a tilt wing aircraft, a vertical takeoff and landing aircraft, an electrical vertical takeoff and landing vehicle, a personal air vehicle, and other suitable types of aircraft.

In this illustrative example, robotic system 202 comprises a number of different components. As depicted, robotic system 202 comprises computer system 212, controller 214, robot 206. As depicted, controller 214 is located in computer system 212.

Controller 214 can be implemented in software, hardware, firmware or a combination thereof. When software is used, the operations performed by controller 214 can be implemented in program instructions configured to run on hardware, such as a processor unit. When firmware is used, the operations performed by controller 214 can be implemented in program instructions and data and stored in persistent memory to run on a processor unit. When hardware is employed, the hardware may include circuits that operate to perform the operations in controller 214.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 212 is a physical hardware system and includes one or more data processing systems. When more than one data processing system is present in computer system 212, those data processing systems are in communication with each other using a communications medium. The communications medium may be a network. The data processing systems may be selected from at least one of a computer, a server computer, a tablet, or some other suitable data processing system.

As depicted, computer system 212 includes a number of processor units 216 that are capable of executing program instructions 218 implementing processes in the illustrative examples. In other words, program instructions 218 are computer readable program instructions.

As used herein, a processor unit in the number of processor units 216 is a hardware device and is comprised of hardware circuits such as those on an integrated circuit that respond to and process instructions and program code that operate a computer. When the number of processor units 216 executes program instructions 218 for a process, the number of processor units 216 can be one or more processor units that are on the same computer or on different computers. In other words, the process can be distributed between processor units 216 on the same or different computers in a computer system 212. Further, the number of processor units 216 can be of the same type or different type of processor units. For example, a number of processor units 216 can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, robot 206 comprises platform 207, end effector 208, and camera system 209. In this depicted example, end effector 208 is connected to platform 207 and camera system 209 is connected to an end effector 208. Camera system 209 can include one or more cameras.

When one component is “connected” to another component, the connection is a physical connection. For example, a first component, camera system 209, can be considered to be physically connected to a second component, end effector 208, by at least one of being secured to the second component, bonded to the second component, mounted to the second component, welded to the second component, fastened to the second component, or connected to the second component in some other suitable manner. The first component also can be connected to the second component using a third component. The first component can also be considered to be physically connected to the second component by being formed as part of the second component, an extension of the second component, or both.

Platform 207 can take a number of different forms. For example, platform 207 can be selected from a group comprising a robotic arm, a crawler, an unmanned aerial vehicle, and other suitable types of platforms that can be connected to an end effector 208. In yet other illustrative examples, platform 207 can be connected to another component or platform. For example, end effector 208 can be connected to a robotic arm that is connected to a crawler or mobile base.

In this illustrative example, object 220 can be held by end effector 208. In this example, robot 206 can move object 220 to perform an operation to manufacture aircraft 204. Controller 214 determines pose 226 for object 220 for use in moving object 220 to different positions. In the illustrative example, pose 226 is position 228 of object 220 and orientation 230 of object 220. Position 228 can be described using two-dimensional or three-dimensional coordinates. Orientation 230 can be with respect to a particular feature or features in object 220. Orientation 230 can indicate the direction that a feature in object 220 points to in this illustrative example.

In this illustrative example, object 220 comprises wire 222 connected to wire contact 224. In this example, pose 226 is for wire contact 224 connected to wire 222. Pose 226 can be for all or a portion of object 220.

In this example, controller 214 controls camera system 209 to generate sequence of images 232 of wire contact 224 while wire contact 224 moves from first position 236 to second position 238. In this illustrative example, sequence of images 232 may not always include the image of wire contact 224 at second position 238.

The sequence of images 232 is sent to controller 214 from camera system 209. In this illustrative example, camera system 209 is stereographic camera 239.

In this example, sequence of images 232 is generated by camera system 209 connected to end effector 208 and wire contact 224 is held by end effector 208. With this configuration, wire 222 does not move with respect to camera system 209. As a result, wire contact 224 does not move in sequence of images 232 while objects in the background can move from image to image in sequence of images 232 generated by camera system 209.

Wire contact 224 can be held directly or indirectly by end effector 208. For example, end effector 208 can directly hold wire contact 224 or indirectly hold wire contact 224 through holding wire 222. When end effector 208 holds wire 222, the location on wire 222 held by end effector 208 is such that wire contact 224 does not move or change pose with respect to camera system 209 when end effector 208 moves from first position 236 to second position 238. In other words, movement of wire contact 224 resulting from vibrations or bending of wire 222 does not occur or is reduced sufficiently to identify wire contact 224 using sequence of images 232.

In this illustrative example, controller 214 detects edges 240 in the sequence of images 232 to form edge images 241. In this example, edge images 241 is comprised of edges 240 detected from sequence of images 232.

In detecting edges 240 in sequence of images 232, controller 214 can identify or extract edges 240 in sequence of images 232 using an edge detection process. This edge detection process can be, for example, a Sobel operator, a Canny edge detector, a Prewitt operator, or other edge detection algorithms.

Controller 214 then creates edge images 241 using edges 240 extracted from sequence of images 232. As depicted, edges 240 includes background edges 242 and contact edges 244. Contact edges 244 are edges 240 for wire contact 224 in sequence of images 232.

In this depicted example, contact edges 244 are considered to be in the foreground. These edges should be the same in different images in sequence of images 232 because wire contact 224 is in a fixed position relative to camera system 209. Background edges 242 are edges 240 for other objects or items in the background of sequence of images 232.

In this illustrative example, controller 214 removes background edges 242 from edges in edge images 241 leaving contact edges 244 in the edges for the wire contact to form a contact edge image 246. Controller 214 can remove background edges 242 in a number of different ways. For example, controller 214 can merge edge images 241 to form combined image 250. Intensities of corresponding pixels in edge images 241 are added to form combined image 250 having pixels 251 with combined intensities 252. Controller 214 can remove edges 240 in combined image 250 that have pixels 251 with combined intensities 252 that are less than a threshold for noise. These edges with combined intensities 252 are less than the threshold are background edges 242. This removal of background edges 242 from edge images 241 in combined image 250 can be performed by controller 214 using median filtering 253 on pixels 251 in combined image 250.

In this depicted example, controller 214 identifies wire contact 224 in contact edge image 246 using contact edges 244 in contact edge image 246. Controller 214 can identify wire contact 224 in contact edge image 246 and a number of different ways. For example, controller 214 can perform image segmentation 255 to identify foreground region 257 in contact edge image 246 for contact edges 244. In the illustrative example, image segmentation 255 can be performed using different image segmentation algorithms. For example, image segmentation 255 can be performed using the GrabCut algorithm. The Grabcut algorithm is an image segmentation based on graph cuts. This algorithm can use iterative graph cuts to identify wire contact 224 in contact edge image 246.

Controller 214 determines pose 226 of wire contact 224 from wire contact 224 identified in contact edge image 246.

When camera system 209 is stereographic camera 239, sequence of images 232 comprises two sets of sequential images 260. Each set is generated by camera in stereographic camera 239. Controller 214 can perform detecting edges 240; removing the background edges; identifying the wire contact using the contact edges in the contact edge image; and determining a pose of the wire contact from the wire contact identified in the contact edge image for the two sets of sequential images to obtain a pair of two dimensional poses 262.

Controller 214 can determine three dimensional pose 267 of wire contact 224 using the pair of two dimensional poses 262. This three dimensional pose can be pose 226 for wire contact 224 and used to move wire contact 224.

Controller 214 can control robot 206 to move wire contact 224 held by end effector 208 to selected position 247 using pose 226 of wire contact 224. For example, controller 214 can move wire contact 224 held by end effector 208 into connector 248 using pose 226 of wire contact 224.

Thus, one or more illustrative examples enable automating wire bundle assembly using robotic system 202. In one or more illustrative examples, robotic system 202 can insert a wire contact for a wire with a desired level of accuracy. Robotic system 202 can determine the pose of a wire contact with the desired level of accuracy that enables robotic system 202 to insert both ends of a wire into connector in an arbitrary order with a higher level of precision as compared to current techniques. Further, the configuration of camera system 209 solves a problem of current techniques using cameras carefully placed around the wire contact and connector. In this example, camera system 209 is connected to robot 206 increasing the flexibility of where robotic system 202 can be used to insert wires into connectors because elaborate setups as used with current techniques are unnecessary.

Additionally, the configuration of robotic system 202 allows for inserting wires in an arbitrary order. This insertion of wires into connector 248 can also be performed with wires already inserted into connector 248. These inserted wires can occlude a target insertion hole in connector 248 for currently used wire insertion systems. With robotic system 202, the occlusion of an insertion hole in connector 248 can be avoided or reduced because camera system 209 is connected to end effector 208 and moves with end effector 208. The images are generated by the camera system 209 are from the point of view of end effector 208 and wire contact 224 remains stationary in the same location within those images enabling generation of images that can reduce the possibility that a hole in a connector is occluded or obscured.

In one illustrative example, one or more technical solutions are present that overcome a technical problem with determining the pose of an object such as a wire contact with a desired level of accuracy to insert the contact into a connector. In the illustrative example, robotic system 202 operates as a robotic wire contact manipulation and pose estimation system.

Computer system 212 can be configured to perform at least one of the steps, operations, or actions described in the different illustrative examples using software, hardware, firmware or a combination thereof. As a result, computer system 212 operates as a special purpose computer system in which controller 214 in computer system 212 determines the pose of an object and use that information to control a robotic system to move the object to a desired location. In particular, controller 214 transforms computer system 212 into a special purpose computer system as compared to currently available general computer systems that do not have controller 214.

The illustration of manufacturing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, although this example is described with respect to a platform in the form of aircraft 204, other illustrative examples can be applied to other types of platforms. The platform can be, for example, a mobile platform, a stationary platform, a land-based structure, an aquatic-based structure, and a space-based structure. More specifically, the platform can be a surface ship, a tank, a personnel carrier, a train, a spacecraft, a space station, a satellite, a submarine, an automobile, a power plant, a bridge, a dam, a house, a manufacturing facility, a building, and other suitable platforms.

In yet other illustrative examples, a robotic system 202 can include additional robots in addition to robot 206. These additional robots can also be controlled by controller 214 or additional controllers in addition to or in place of controller 214.

The illustration of manufacturing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, although object 220 has been described with respect to a wire with a wire contact, other illustrative examples can be used to determine the pose of other types of objects. For example, an object can be selected from a group comprising a fastener, a rivet, a screw, a nut, a bolt, a hex standoff, a retaining ring, an integrated a chip containing an integrated circuit, a part, an assembly, and other suitable objects that can be held by an end effector and moved to various locations to manufacture aircraft 204.

In yet another illustrative example, the different operations performed using robot 206 can be used in other operations of the manufacturing of aircraft or other platforms. For example, controller 214 can control robot 206 to perform maintenance operations.

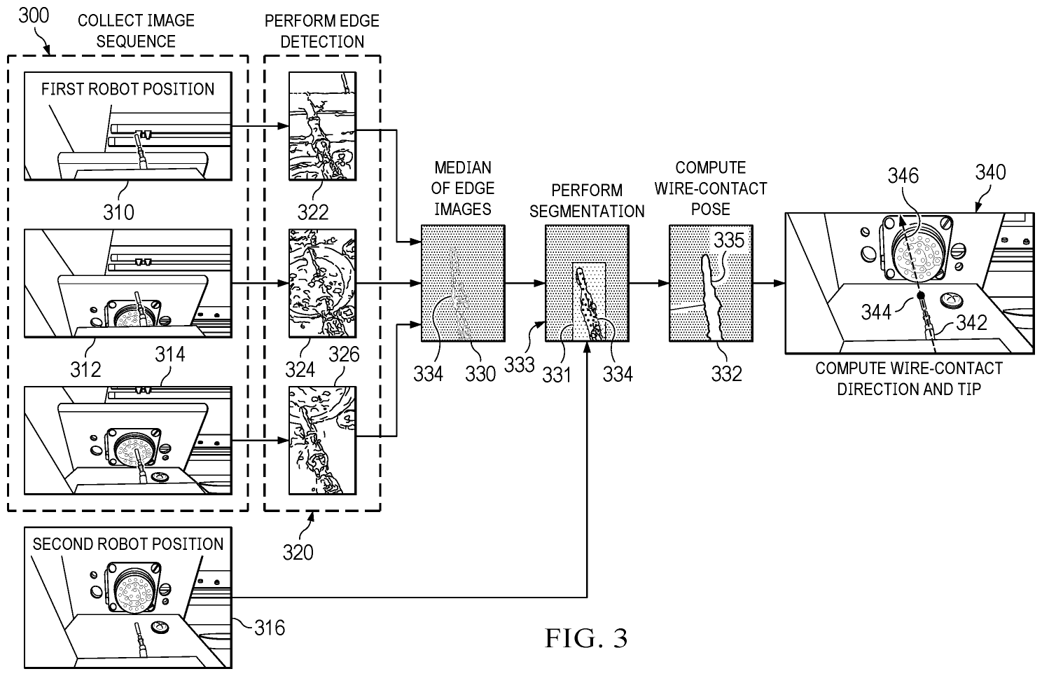

Turning now to FIG. 3, an illustration of dataflow for determining the pose of a wire contact is depicted in accordance with an illustrative embodiment. This dataflow can be performed using robotic system 202 and FIG. 2. For example, the dataflow can be processed by controller 214 in FIG. 2.

In this illustrative example, sequence of images 300 are generated from a first robot position to a second robot position. Sequence of images 300 is an example of sequence of images 232 generated by camera system 209 in FIG. 2. In this illustrative example, the robot positions are positions of an effector for the robot. The first robot position can be, for example, first position 236 in FIG. 2 and the second robot position can be second position 238 in FIG. 2.

As depicted, sequence of images 300 comprises first image 310, second image 312, and third image 314. In this example, fourth image 316 is generated at the second robot position. Fourth image 316 represents the terminal position of the end effector and is not included in sequence of images 300 in this example. In other illustrative examples, fourth image 316 can be part of sequence of images 300.

As depicted, first image 310 in sequence of images 300 is generated at first robot position. Second image 312 and third image 314 in sequence of images 300 are generated as the robot moves the wire connector from the first robot position to the second robot position.

In this illustrative example, edges can be extracted from each of the images in sequence of images 300. In other words, edges can be detected for each individual image. In this illustrative example, edge detection can be performed using an edge detection algorithm such as a Canny edge detector, a Deriche edge detector, and other suitable algorithms for processes that can detect edges of objects in images.

In this illustrative example, edge images 320 are the result of performing edge detection on sequence of images 300. Edge images 320 are an example of edge images 241 in FIG. 2.

As depicted, edge images 320 comprise first edge image 322, second edge image 324, and third edge image 326. First edge image 322 is generated from performing edge detection on first image 310 and second edge image 324 is generated from performing edge detection on second image 312. Third edge image 326 is generated from performing edge detection on third image 314.

Next, edges corresponding to the background in edge images 320 are removed. These edges are removed across first edge image 322, second edge image 324, and third edge image 326. In this example, the edges in the foreground are edges for the wire contact. These edges are in consistent locations in edge images 320 because the wire contact is held in a fixed position relative to the camera. In this depicted example, both the wire contact and the camera are connected to the end effector. For example, the wire contact is held by the end effector and the camera is attached to or part of the end effector. As result, edges for the wire contact have the same pixel locations in edge images 320.

In this illustrative example, the background edges can be removed by determining the median of edges across edge images 320. This process can remove edges that do not consistently appear within edge images 320. These edges do not consistently appear in the same locations in the different images because the background moves in edge images 320 because the background is not fixed relative to the camera. Contact edges for the wire contact can be detected in edge images 320 as belonging to the wire contact because the wire contact remains stationary relative to camera.

The result of this process for determining the median of edge images is contact edge image 330. This contact edge image is an example of contact edge image 246 in FIG. 2 and contains median edge pixels 334 for contact edges for the contact.

In this example, wire contact can be determined from edge images 320 using various algorithms. For example, the segmentation algorithm can be used to identify a region in contact edge image 330 that defines the wire contact. This region can also be referred to as a segment for the wire contact. A portion of the original images from sequence of images 300 or fourth image 316, which include median edge pixels 334 in contact edge image 330 are applied as an input to the segmentation algorithm. The segmentation algorithm can be, for example, the Grabcut algorithm.

In this example, the portion of fourth image 316 that intersects the median edge pixels 334 in contact edge image 330 is taken as input to the Grabcut algorithm, along with bounding box 331 defining the search region containing median edge pixels 334 for the contact for the algorithm. Bounding box 331 is selected to encompass median edge pixels 334 for contact edges for the contact in edge image to form bounded contact edge image 333.

As depicted, the result of performing segmentation on bounded contact edge image 333 is contact region image 332. This contact region image white pixels in a region for wire contact segment 335. This wire contact segment defines the wire contact. The black pixels in the other region form the background.

With the identification of wire contact segment 335, the pose for the wire contact can be determined. For example, the covariance of the points corresponding to the wire contact segment can be determined. The process can then determine their eigenvectors (x and y in the Cartesian image space). In this example, the eigenvector corresponding to widest distribution of points is the estimated direction of the contact.

In this example, the pose for the wire contact as shown in image 340. In this example, the pose for wire contact 342 in image 340 is the position of tip 344. The pose also includes the orientation in the form of direction 346 for wire contact 342.

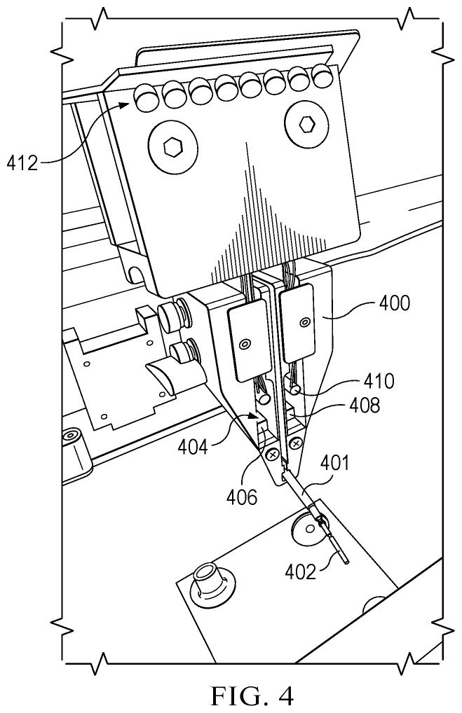

Turning now to FIG. 4, an illustration of an end effector for a robotic arm is depicted in accordance with an illustrative embodiment. In this illustrative example, end effector 400 is an example of one implementation for end effector 208 in FIG. 2. In this illustrative example, end effector 400 is configured for wire insertion. As depicted, end effector 400 holds wire 401 with wire contact 402. As depicted, stereographic camera 404 is connected to end effector 400. Stereographic camera 404 comprises first camera 406 and second camera 408. In this illustrative example, stereographic camera 404 also includes lighting in the form of light emitting diode (LED) system 410. Stereographic camera 404 is an example of stereographic camera 239 in FIG. 2. Additional lighting is provided by overhead light emitting diode (LED) array 412.

As depicted in this example, placement of stereographic camera 404, light emitting diode system 410, and light emitting diode array 412 can direct light at wire contact 402 and reduce the effects of environmental light when generating images of wire contact 402. As a result, stereographic camera 404 can generate images that enable detecting wire contacts with more consistency.

With this configuration, first camera 406, second camera 408, light emitting diode (LED) system 410, overhead light emitting diode (LED) array 412, wire contact 402 are stationary with respect to each other. As result, wire contact 402 does not move within the field of view of first camera 406 and second camera 408 when end effector 400 moves from one location to another location. Further, the lighting provided by light emitting diode (LED) system 410 and overhead light emitting diode (LED) array 412 remains consistent without changing with respect to wire contact 402.

Thus, the collection of images using this configuration can provide a desired quality to increase the ability to detect wire contact 402. For example, these images can be used in edge detection, computing the median edges, performing segmentation of the median edges to determine a region for wire contact 402, and determining the pose of wire contact 402. In this example, the pose can include a position of the tip or other part of wire contact 402 as well as orientation in the form of a direction for wire contact 402.

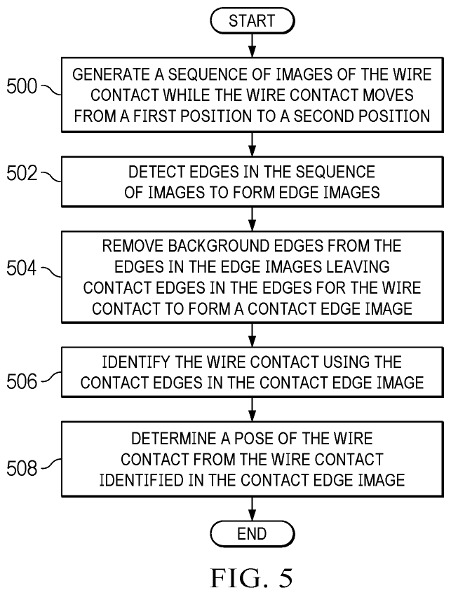

Turning next to FIG. 5, an illustration of a flowchart of a process for positioning a wire contact is depicted in accordance with an illustrative embodiment. The process in FIG. 5 can be implemented in hardware, software, or both. When implemented in software, the process can take the form of program instructions that are run by one of more processor units located in one or more hardware devices in one or more computer systems. For example, the process can be implemented in controller 214 in computer system 212 in FIG. 2.

The process begins by generating a sequence of images of the wire contact while the wire contact moves from a first position to a second position (operation 500). In operation 500, the sequence of images is generated by a camera system connected to an end effector and the wire contact is held by the end effector.

The process detects edges in the sequence of images to form edge images (operation 502). The process removes background edges from the edges in the edge images leaving contact edges in the edges for the wire contact to form a contact edge image (operation 504).

The process identifies the wire contact using the contact edges in the contact edge image (operation 506). The process determines a pose of the wire contact from the wire contact identified in the contact edge image (operation 508). The process terminates thereafter.

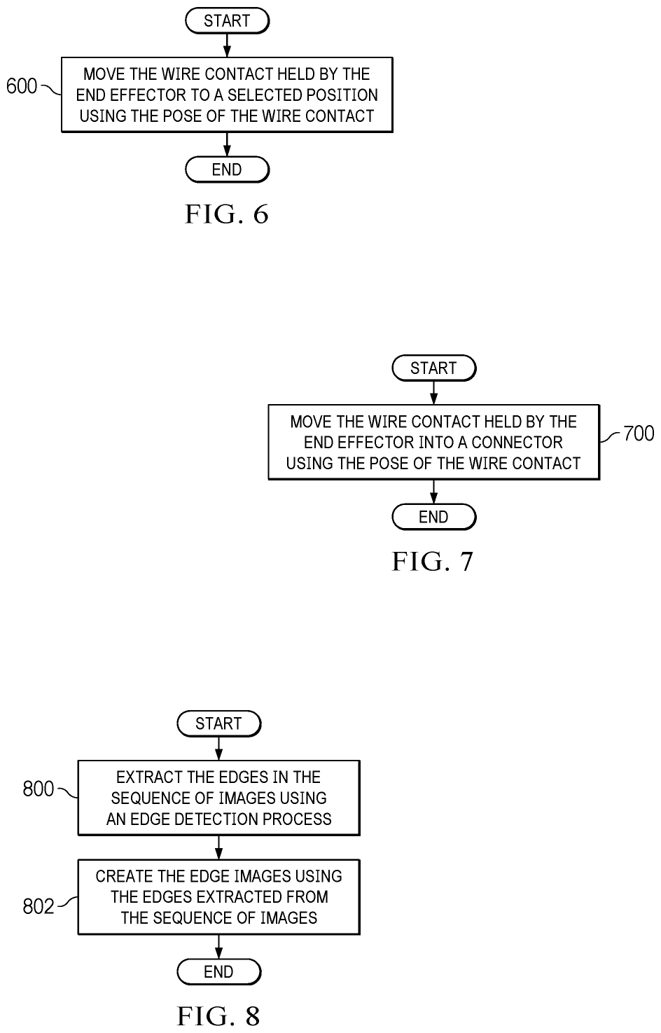

With reference now to FIG. 6, an illustration of a flowchart of a process for positioning a wire contact is depicted in accordance with an illustrative embodiment. The operation depicted in this figure is an example of an additional operation that can be performed with the operations in FIG. 5.

The process moves the wire contact held by the end effector to a selected position using the pose of the wire contact (operation 600). The process terminates thereafter.

With reference next to FIG. 7, an illustration of a flowchart of a process for positioning a wire contact is depicted in accordance with an illustrative embodiment. The operation depicted in this figure is an example of an additional operation that can be performed with the operations in FIG. 5.

The process moves the wire contact held by the end effector into a connector using the pose of the wire contact (operation 700). The process terminates thereafter.

In FIG. 8, an illustration of a flowchart of a process for detecting edges is depicted in accordance with an illustrative embodiment. The process illustrated in FIG. 8 is an example of one implementation for operation 502 in FIG. 5.

The process begins by extracting the edges in the sequence of images using an edge detection process {operation 800). The process creates the edge images using the edges extracted from the sequence of images (operation 802). The process terminates thereafter.

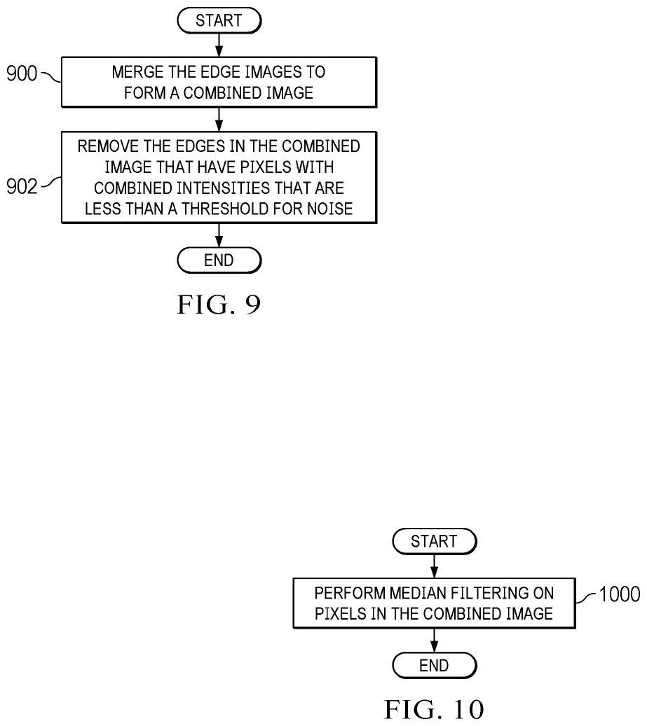

With reference now to FIG. 9, an illustration of a flowchart of process for removing background edges is depicted in accordance with an illustrative embodiment. The process in this figure is an example of an implementation for operation 504 in FIG. 5.

The process begins by merging the edge images to form a combined image (operation 900). In operation 900, intensities of corresponding pixels in the edge images are added to form the combined image having combined intensities.

The process removes the edges in the combined image that have pixels with combined intensities that are less than a threshold for noise (operation 902). The process terminates thereafter. In operation 902, the remaining edges are the contact edges for contact edge image.

Turning to FIG. 10, an illustration of a flowchart of a process for removing edges is depicted in accordance with an illustrative embodiment. The process illustrated in FIG. 10 is an example of an implementation for operation 902 in FIG. 9.

The process performs median filtering on pixels in the combined image (operation 1000). The process terminates thereafter. In operation 1000, the median filtering removes the background edges.

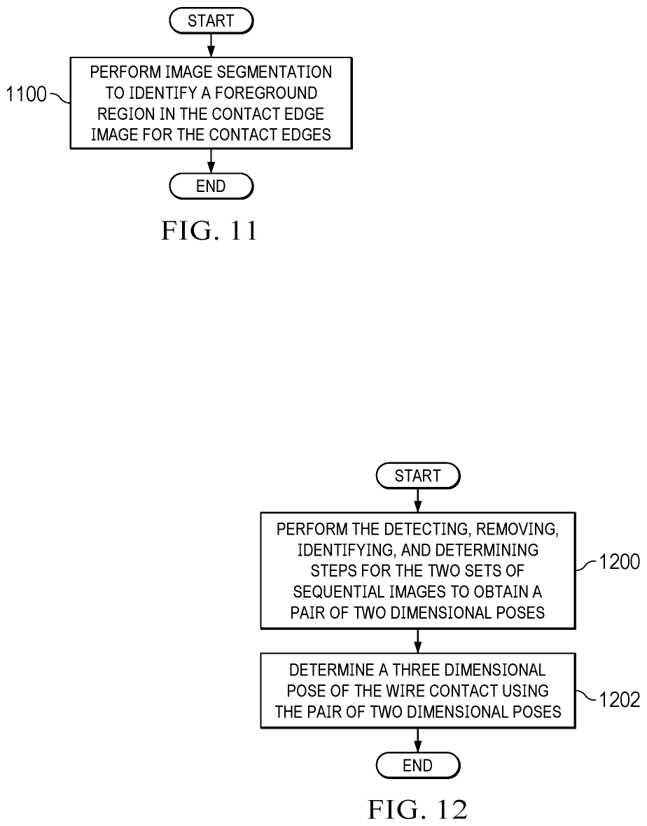

Next in FIG. 11, an illustration of a flowchart of a process for identifying a wire contact in a contact edge image is depicted in accordance with an illustrative embodiment. The process illustrated in FIG. 11 is an example of an implementation for operation 506 in FIG. 5.

The process performs image segmentation to identify a foreground region in the contact edge image for the contact edges (operation 1100). The process terminates thereafter. The use of image segmentation identifies the wire contact that is in the foreground region.

With reference now to FIG. 12, an illustration of a flowchart of a process for processing images to determine the pose of a wire contact using a stenographic camera is depicted in accordance with an illustrative embodiment. The process illustrated in this figure is an example of additional steps that can be performed with the process in FIG. 5. In this process, the sequence of images comprises two sets of sequential images generated by each of the cameras in the stenographic camera system.

The process performs the detecting, removing, identifying, and determining steps for the two sets of sequential images to obtain a pair of two dimensional poses (operation 1200). In operation 1200, these steps are detecting edges in the sequence of images to form edge images; removing background edges from the edges in the edge images leaving contact edges in the edges for the wire contact to form a contact edge image; identifying the wire contact using the contact edges in the contact edge image; and determining a pose of the wire contact from the wire contact identified in the contact edge image.

The process determines a three dimensional pose of the wire contact using the pair of two dimensional poses (operation 1202). The process terminates thereafter.

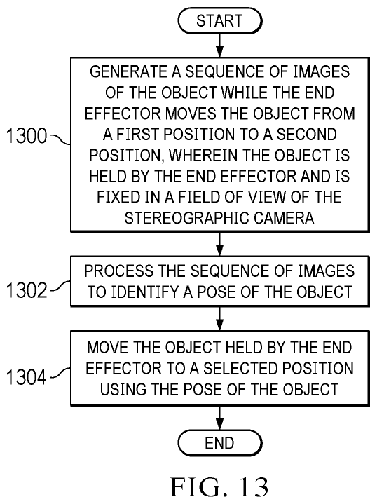

Turning next to FIG. 13, an illustration of a flowchart of a process for positioning an object is depicted in accordance with an illustrative embodiment. The process illustrated in FIG. 13 can be implemented in hardware, software, or both. When implemented in software, the process can take the form of program instructions that are run by one of more processor units located in one or more hardware devices in one or more computer systems. For example, the process can be implemented in controller 214 in computer system 212 in FIG. 2.

The process begins by generating a sequence of images of the object while the end effector moves the object from a first position to a second position, wherein the object is held by the end effector and is fixed in a field of view of the stereographic camera (operation 1300). In operation 1300, the sequence of images is generated by stenographic camera connected to an end effector.

The process processes the sequence of images to identify a pose of the object (operation 1302). The process moves the object held by the end effector to a selected position using the pose of the object (operation 1304). The process terminates thereafter.

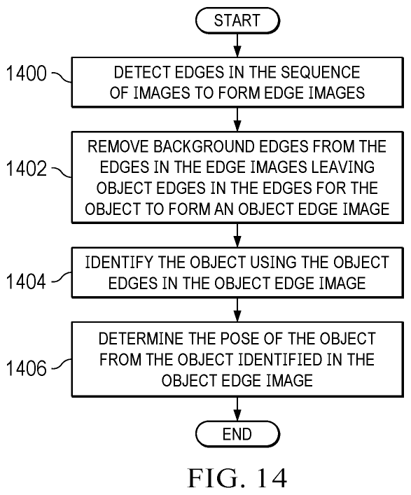

With reference to FIG. 14, an illustration of a flowchart of a process for processing a sequence of images is depicted in accordance with an illustrative embodiment. The process illustrated in FIG. 14 is an example of an implementation for operation 1302 in FIG. 13.

The process begins by detecting edges in the sequence of images to form edge images (operation 1400). The process removes background edges from the edges in the edge images leaving object edges in the edges for the object to form an object edge image (operation 1402).

The process identifies the object using the object edges in the object edge image (operation 1404). The process determines the pose of the object from the object identified in the object edge image (operation 1406). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program instructions, hardware, or a combination of the program instructions and hardware. When implemented in hardware, the hardware can, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

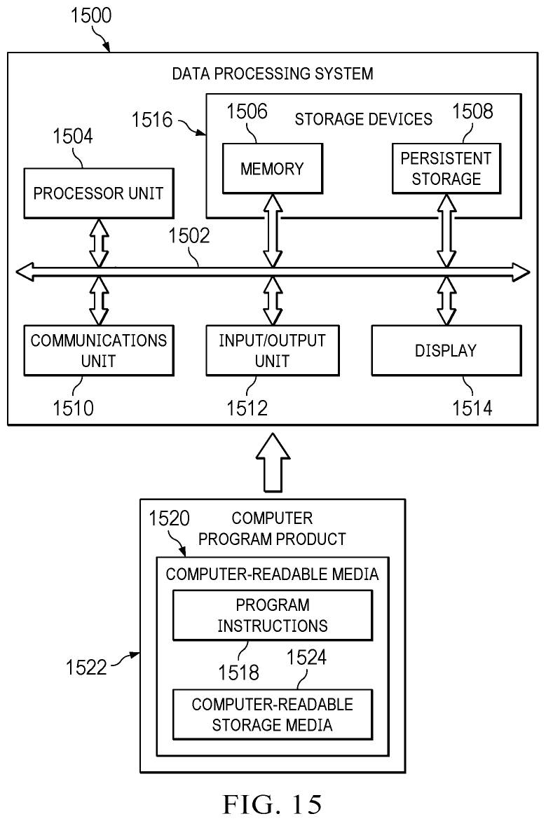

Turning now to FIG. 15, a block diagram of a data processing system is depicted in accordance with an illustrative embodiment. Data processing system 1500 can be used to implement server computer 104, server computer 106, and client devices 110 in FIG. 1. Data processing system 1500 can also be used to implement computer system 212 in FIG. 2. In this illustrative example, data processing system 1500 includes communications framework 1502, which provides communications between processor unit 1504, memory 1506, persistent storage 1508, communications unit 1510, input/output (I/O) unit 1512, and display 1514. In this example, communications framework 1502 takes the form of a bus system.

Processor unit 1504 serves to execute instructions for software that can be loaded into memory 1506. Processor unit 1504 includes one or more processors. For example, processor unit 1504 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1504 can may be implemented using one or more heterogeneous processor systems in which a main processor is present with secondary processors on a single chip. As another illustrative example, processor unit 1504 can be a symmetric multi-processor system containing multiple processors of the same type on a single chip.

Memory 1506 and persistent storage 1508 are examples of storage devices 1516. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1516 may also be referred to as computer-readable storage devices in these illustrative examples. Memory 1506, in these examples, can be, for example, a random-access memory or any other suitable volatile or non-volatile storage device. Persistent storage 1508 may take various forms, depending on the particular implementation.

For example, persistent storage 1508 may 1508 may contain one or more components or devices. For example, persistent storage 1508 can be a hard drive, a solid-state drive (SSD), a flash memory, a rewritable optical disk, a rewritable magnetic tape, or some combination of the above. The media used by persistent storage 1508 also can be removable. For example, a removable hard drive can be used for persistent storage 1508.

Communications unit 1510, in these illustrative examples, provides for communications with other data processing systems or devices. In these illustrative examples, communications unit 1510 is a network interface card.

Input/output unit 1512 allows for input and output of data with other devices that can be connected to data processing system 1500. For example, input/output unit 1512 may provide a connection for user input through at least one of a keyboard, a mouse, or some other suitable input device. Further, input/output unit 1512 may send output to a printer. Display 1514 provides a mechanism to display information to a user.

Instructions for at least one of the operating system, applications, or programs can be located in storage devices 1516, which are in communication with processor unit 1504 through communications framework 1502. The processes of the different embodiments can be performed by processor unit 1504 using computer-implemented instructions, which may be located in a memory, such as memory 1506.

These instructions are referred to as program instructions, computer usable program instructions, or computer-readable program instructions that can be read and executed by a processor in processor unit 1504. The program instructions in the different embodiments can be embodied on different physical or computer-readable storage media, such as memory 1506 or persistent storage 1508.

Program instructions 1518 is located in a functional form on computer-readable media 1520 that is selectively removable and can be loaded onto or transferred to data processing system 1500 for execution by processor unit 1504. Program instructions 1518 and computer-readable media 1520 form computer program product 1522 in these illustrative examples. In the illustrative example, computer-readable media 1520 is computer readable storage media 1524.

Computer readable storage media 1524 is a physical or tangible storage device used to store program instructions 1518 rather than a medium that propagates or transmits program instructions 1518. Computer readable storage media 1524 maybe at least one of an electronic storage medium, a magnetic storage medium, an optical storage medium, an electromagnetic storage medium, a semiconductor storage medium, a mechanical storage medium, or other physical storage medium. Some known types of storage devices that include these mediums include: a diskette, a hard disk, a random access memory (RAM), a read-only memory (ROM), an erasable programmable read-only memory (EPROM or Flash memory), a static random access memory (SRAM), a compact disc read-only memory (CD-ROM), a digital versatile disk (DVD), a memory stick, a floppy disk, a mechanically encoded device, such as punch cards or pits/lands formed in a major surface of a disc, or any suitable combination thereof.

Computer readable storage media 1524, as that term is used in the present disclosure, is not to be construed as storage in the form of transitory signals per se, such as at least one of radio waves or other freely propagating electromagnetic waves, electromagnetic waves propagating through a waveguide, light pulses passing through a fiber optic cable, electrical signals communicated through a wire, or other transmission media.

Further, data can be moved at some occasional points in time during normal operations of a storage device. These normal operations include access, de-fragmentation or garbage collection. However, these operations do not render the storage device as transitory because the data is not transitory while the data is stored in the storage device.

Alternatively, program instructions 1518 can be transferred to data processing system 1500 using a computer-readable signal media. The computer-readable signal media are signals and can be, for example, a propagated data signal containing program instructions 1518. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1520” can be singular or plural. For example, program instructions 1518 can be located in computer-readable media 1520 in the form of a single storage device or system. In another example, program instructions 1518 can be located in computer-readable media 1520 that is distributed in multiple data processing systems. In other words, some instructions in program instructions 1518 can be located in one data processing system while other instructions in program instructions 1518 can be located in one data processing system. For example, a portion of program instructions 1518 can be located in computer-readable media 1520 in a server computer while another portion of program instructions 1518 can be located in computer-readable media 1520 located in a set of client computers.

The different components illustrated for data processing system 1500 are not meant to provide architectural limitations to the manner in which different embodiments can be implemented. In some illustrative examples, one or more of the components may be incorporated in or otherwise form a portion of, another component. For example, memory 1506, or portions thereof, may be incorporated in processor unit 1504 in some illustrative examples. The different illustrative embodiments can be implemented in a data processing system including components in addition to or in place of those illustrated for data processing system 1500. Other components shown in FIG. 15 can be varied from the illustrative examples shown. The different embodiments can be implemented using any hardware device or system capable of running program instructions 1518.

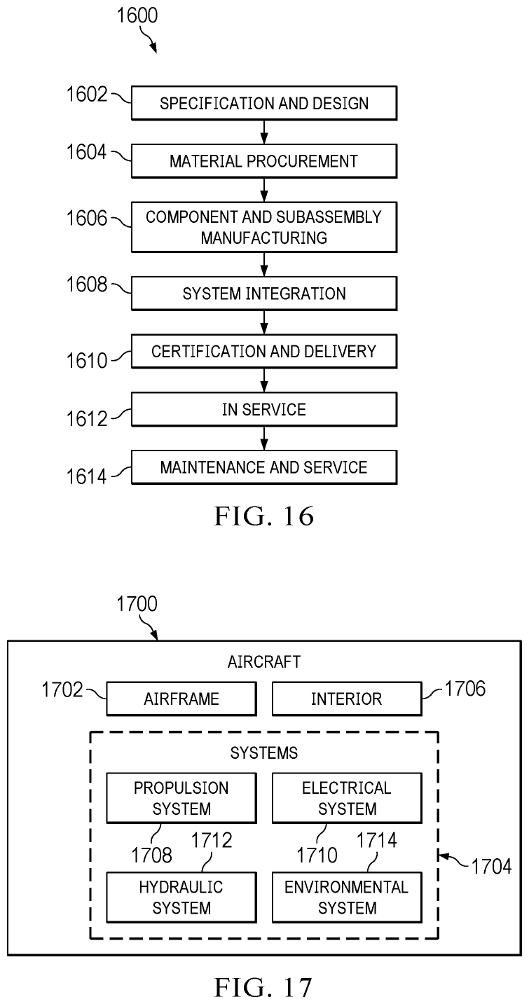

Illustrative embodiments of the disclosure may be described in the context of aircraft manufacturing and service method 1600 as shown in FIG. 16 and aircraft 1700 as shown in FIG. 17. Turning first to FIG. 16, an illustration of an aircraft manufacturing and service method is depicted in accordance with an illustrative embodiment. During pre-production, aircraft manufacturing and service method 1600 may include specification and design 1602 of aircraft 1700 in FIG. 17 and material procurement 1604.

During production, component and subassembly manufacturing 1606 and system integration 1608 of aircraft 1700 in FIG. 17 takes place. Thereafter, aircraft 1700 in FIG. 17 can go through certification and delivery 1610 in order to be placed in service 1612. While in service 1612 by a customer, aircraft 1700 in FIG. 17 is scheduled for routine maintenance and service 1614, which may include modification, reconfiguration, refurbishment, and other maintenance or service.

Each of the processes of aircraft manufacturing and service method 1600 maybe performed or carried out by a system integrator, a third party, an operator, or some combination thereof. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 17, an illustration of an aircraft is depicted in which an illustrative embodiment may be implemented. In this example, aircraft 1700 is produced by aircraft manufacturing and service method 1600 in FIG. 16 and may include airframe 1702 with plurality of systems 1704 and interior 1706. Examples of systems 1704 include one or more of propulsion system 1708, electrical system 1710, hydraulic system 1712, and environmental system 1714. Any number of other systems may be included. Although an aerospace example is shown, different illustrative embodiments may be applied to other industries, such as the automotive industry.

Apparatuses and methods embodied herein may be employed during at least one of the stages of aircraft manufacturing and service method 1600 in FIG. 16.

In one illustrative example, components or subassemblies produced in component and subassembly manufacturing 1606 in FIG. 16 can be fabricated or manufactured in a manner similar to components or subassemblies produced while aircraft 1700 is in service 1612 in FIG. 16. As yet another example, one or more apparatus embodiments, method embodiments, or a combination thereof can be utilized during production stages, such as component and subassembly manufacturing 1606 and system integration 1608 in FIG. 16. One or more apparatus embodiments, method embodiments, or a combination thereof may be utilized while aircraft 1700 is in service 1612, during maintenance and service 1614 in FIG. 16, or both. The use of a number of the different illustrative embodiments may substantially expedite the assembly of aircraft 1700, reduce the cost of aircraft 1700, or both expedite the assembly of aircraft 1700 and reduce the cost of aircraft 1700.

For example, robotic system 202 can be used during component and subassembly manufacturing 1606 to assemble wire bundles for wiring harnesses used in aircraft 1700. As another example, robotic system 202 can also be used to assemble wire bundles for components used in maintenance and service 1614. Also, robotic system 202 can be used to manipulate other objects in addition to or in place of inserting wire contacts for wires into connectors.

Thus, the illustrative examples provide a method, apparatus, system, and computer program product for positions a wire contact. A sequence of images of a wire contact is generated while the wire contact moves from a first position to a second position. The sequence of images is generated by the camera system connected to the end effector and the wire contact is held by the end effector. Edges are detected in the sequence of images to form edge images. Background edges are removed from the edges in the edge images leaving contact edges in the edges for the wire contact to form a contact edge image. The wire contact is identified using the contact edges in the contact edge image. A pose of the wire contact is determined from the wire contact identified in the contact edge image.

In an illustrative example, the camera system is connected to the end effector forming the wire contact or other object. As result, the wire contact does not move during the generation of images by the camera system even when the end effector moves the wire contact from one position to another position. As result, the image processing can remove background features leaving the wire contact without using complex modeling systems such as machine learning models. The wire contact in the image can be used to determine the pose of the image. That pose can then be used to move the image to different positions in performing various to operations using the wire contact.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A robotic system comprising:
an end effector;
a camera system connected to the end effector; and
a controller, wherein the controller is configured to:
generate a sequence of images of a wire contact while the wire contact moves from a first position to a second position, wherein the sequence of images is generated by the camera system connected to the end effector and the wire contact is held by the end effector;
detect edges in the sequence of images to form edge images;
remove background edges from the edges in the edge images leaving contact edges in the edges for the wire contact to form a contact edge image;
identify the wire contact using the contact edges in the contact edge image; and
determine a pose of the wire contact from the wire contact identified in the contact edge image.

2. The robotic system of claim 1, wherein the controller is configured to:
move the wire contact held by the end effector to a selected position using the pose of the wire contact.

3. The robotic system of claim 1, wherein the controller is configured to:
move the wire contact held by the end effector into a connector using the pose of the wire contact.

4. The robotic system of claim 1, wherein in detecting the edges in the sequence of images, the controller is configured to:
extract the edges in the sequence of images using an edge detection process; and
create the edge images using the edges extracted from the sequence of images.

5. The robotic system of claim 1, wherein in removing the background edges from the edges in the edge images leaving the contact edges in the edges to form the contact edge image comprising the contact edges for the wire contact, the controller is configured to:
merge the edge images to form a combined image, wherein intensities of corresponding pixels in the edge images are added to form the combined image having pixels with combined intensities; and
remove the edges in the combined image that have pixels with the combined intensities that are less than a threshold for noise, wherein remaining edges are the contact edges for contact edge image.

6. The robotic system of claim 5, wherein in removing the edges in the combined image that have the combined intensities that are less than the threshold for noise, wherein the remaining edges are the contact edges, the controller is configured to:
perform median filtering on pixels in the combined image.

7. The robotic system of claim 1, wherein in identifying the wire contact using the contact edges in the contact edge image, the controller is configured to:
perform image segmentation to identify a foreground region in the contact edge image for the contact edges.

8. The robotic system of claim 1, wherein the camera system is a stereographic camera and wherein the sequence of images comprises two sets of sequential images generated by each of the cameras in the stereographic camera and wherein the controller is configured to:
perform detecting the edges in the sequence of images to form the edge images; removing the background edges from the edges in the edge images leaving the contact edges in the edges for the wire contact to form the contact edge image; identifying the wire contact using the contact edges in the contact edge image; and determining a pose of the wire contact from the wire contact identified in the contact edge image for the two sets of sequential images to obtain a pair of two dimensional poses; and
determine a three dimensional pose of the wire contact using the pair of two dimensional poses.

9. The robotic system of claim 1, wherein the end effector is connected to a platform selected from a group comprising a robotic arm, a crawler, and an unmanned aerial vehicle.

10. The robotic system of claim 1, wherein the camera system is a stereographic camera.

11. A method for positioning a wire contact, the method comprising:
generating, by a computer system, a sequence of images of the wire contact while the wire contact moves from a first position to a second position, wherein the sequence of images is generated by a camera system connected to an end effector and the wire contact is held by the end effector;
detecting, by the computer system, edges in the sequence of images to form edge images;
removing, by the computer system, background edges from the edges in the edge images leaving contact edges in the edges for the wire contact to form a contact edge image;
identifying, by the computer system, the wire contact using the contact edges in the contact edge image; and
determining, by the computer system, a pose of the wire contact from the wire contact identified in the contact edge image.

12. The method of claim 11 further comprising:
moving, by the computer system, the wire contact held by the end effector to a selected position using the pose of the wire contact.

13. The method of claim 11 further comprising:
moving, by the computer system, the wire contact held by the end effector into a connector using the pose of the wire contact.

14. The method of claim 11, wherein detecting, by the computer system, the edges in the sequence of images comprises:
extracting, by the computer system, the edges in the sequence of images using an edge detection process; and
creating, by the computer system, the edge images using the edges extracted from the sequence of images.

15. The method of claim 11, wherein removing, by the computer system, the background edges from the edges in the edge images leaving the contact edges in the edges to form the contact edge image comprising the contact edges for the wire contact comprises:
merging, by the computer system, the edge images to form a combined image, wherein intensities of corresponding pixels in the edge images are added to form the combined image having combined intensities; and
removing, by the computer system, the edges in the combined image that have pixels with the combined intensities that are less than a threshold for noise, wherein remaining edges are the contact edges for contact edge image.

16. The method of claim 15, wherein removing, by the computer system, the edges in the combined image that have the combined intensities that are less than the threshold for noise, wherein the remaining edges are the contact edges comprises:
performing, by the computer system, median filtering on pixels in the combined image.

17. The method of claim 11, wherein identifying, by the computer system, the wire contact using the contact edges in the contact edge image comprises:
performing, by the computer system, image segmentation to identify a foreground region in the contact edge image for the contact edges.

18. The method of claim 11, wherein the camera system is a stereographic camera and wherein the sequence of images comprises two sets of sequential images generated by each of the cameras in the stereographic camera and further comprising:
performing, by the computer system, the detecting, removing, identifying, and detecting steps for the two sets of sequential images to obtain a pair of two dimensional poses; and
determining, by the computer system, a three dimensional pose of the wire contact using the pair of two dimensional poses.

19. The method of claim 11, wherein the end effector is connected to a platform selected from a group comprising a robotic arm, a crawler, and an unmanned aerial vehicle.

20. The method of claim 11, wherein the camera system is a stereographic camera.

21. A method for positioning an object, the method comprising:
generating, by a stereographic camera connected to an end effector, a sequence of images of the object while the end effector moves the object moves from a first position to a second position, wherein the object is held by end effector and is fixed in a field of view of the stereographic camera;
processing, by a computer system, the sequence of images to identify a pose of the object; and
moving, by the end effector, the object held by the end effector to a selected position using the pose of the object.

22. The method of claim 21, wherein processing the sequence of images to identify a pose of the object comprises:
detecting, by the computer system, edges in the sequence of images to form edge images;
removing, by the computer system, background edges from the edges in the edge images leaving object edges in the edges for the object to form an object edge image;
identifying, by the computer system, object using the object edges in the object edge image; and
determining, by the computer system, the pose of the object from the object identified in the object edge image.

23. The method of claim 21, wherein the end effector is connected to a platform selected from a group comprising a robotic arm, a crawler, and an unmanned aerial vehicle.

24. A computer program product for positioning a wire contact, the computer program product comprising a computer readable storage medium having program instructions embodied therewith, the program instructions executable by a computer system to cause the computer system to perform a method of:
generating a sequence of images of the wire contact while the wire contact moves from a first position to a second position, wherein the sequence of images is generated by a camera system connected to an end effector and the wire contact is held by the end effector;
detecting edges in the sequence of images to form edge images;
removing, by the computer system, background edges from the edges in the edge images leaving contact edges in the edges for the wire contact to form a contact edge image;
identifying the wire contact using the contact edges in the contact edge image; and
determining a pose of the wire contact from the wire contact identified in the contact edge image.
